(19) United States
(12) Patent Application Publication
(10) Pub. No.: US 2024/0369916 A1
(43) Pub. Date: Nov. 7, 2024

(54) LIGHT SOURCE MODULE AND PROJECTOR

(71) Applicant: SONY GROUP CORPORATION, Tokyo (JP)

(72) Inventor: Atsuhiro HORI, Tokyo (JP)

(73) Assignee: SONY GROUP CORPORATION, Tokyo (JP)

(21) Appl. No.: 18/686,068

(22) PCT Filed: Mar. 17, 2022
(86) PCT No.: PCT/JP2022/012130

§ 371 Date: Feb. 23, 2024

(30) Foreign Application Priority Data
Sep. 1, 2021 (JP) 2021-142353

(51) Int. Cl. G03B 21/20

(52) U.S. Cl. CPC G03B 21/204; G03B 21/2066; G03B 21/2073

(57) ABSTRACT

A light source module includes: a light source section that emits excitation light; a wavelength conversion section that outputs first light and second light that are in mutually different wavelength bands; a fluorescent substance region that absorbs the excitation light and outputs the first light together with the second light, the first light being fluorescent light in a different wavelength band from the excitation light, the fluorescent substance region being provided in the wavelength conversion section; a reflection region that outputs the excitation light as the second light in a different angular distribution from the second light output from the fluorescent substance region, the reflection region being provided in the wavelength conversion section; and a region-division wavelength selector including a first region and a second region, the first region transmitting the first light and the second light, the second region reflecting or absorbing the second light selectively.

### TECHNICAL FIELD

The present disclosure relates to a light source module including two light valves and a wavelength converter as a light source, and a projector including the light source module.

### BACKGROUND ART

For example, PTL 1 discloses an illumination optical system including a light source emitting light of a first wavelength, a fluorophore unit, an optical element, and a quarter-wave plate provided between the optical element and the fluorophore unit. The fluorophore unit of the illumination optical system has a reflection region and a fluorophore region emitting fluorescent light of a wavelength that differs from the first wavelength by radiation of light of the first wavelength.

### CITATION LIST

### Patent Literature

PTL 1: WO 2012/127554

### SUMMARY OF THE INVENTION

Meanwhile, it has been desired for projectors using two light valves to improve its color gamut.

Therefore, it is desirable to provide a light source module and a projector that make it possible to widen the color gamut.

A light source module according to an embodiment of the present disclosure includes: a light source section that emits excitation light; a wavelength conversion section that outputs first light and second light that are in mutually different wavelength bands; a fluorescent substance region that absorbs the excitation light and outputs the first light together with the second light, the first light being fluorescent light in a different wavelength band from the excitation light, the fluorescent substance region being provided in the wavelength conversion section; a reflection region that outputs the excitation light as the second light in a different angular distribution from the second light output from the fluorescent substance region, the reflection region being provided in the wavelength conversion section; and a region-division wavelength selector including a first region and a second region, the first region transmitting the first light and the second light, the second region reflecting or absorbing the second light selectively.

A projection according to an embodiment of the present disclosure includes the above-described light source module according to the embodiment of the present disclosure.

The light source module and the projector according to the embodiment of the present disclosure is configured in such a manner that the wavelength conversion section has the fluorescent substance region of absorbing the excitation light and outputting fluorescent light as the first light and the reflection region of reflecting the excitation light and outputting the reflected light as the second light, and the wavelength conversion section outputs second light from the reflection region in a different angular distribution from second light output from the fluorescent substance region together with the first light. In addition, the light source module and the projector further includes the region-division wavelength selector having the first region and the second region, the first region transmitting the first light and the second light, the second region reflecting or absorbing the second light selectively. This makes it possible to spatially separate the second light output from the fluorescent substance region from the second light output from the reflection region.

### BRIEF DESCRIPTION OF DRAWING

FIG. 1 is an overview diagram illustrating a configuration example of a light source module according to an embodiment of the present disclosure and a projector including the light source module.

FIG. 2 is a schematic plan view of an example of a configuration of a wavelength conversion section illustrated in FIG. 1.

FIG. 3 is a schematic cross-sectional view of a polarization maintaining diffuser plate illustrated in FIG. 2.

FIG. 4 is a perspective view for describing a surface structure of the polarization maintaining diffuser plate illustrated in FIG. 2.

FIG. 5 is a diagram illustrating an angular distribution of blue light output from the reflection region illustrated in FIG. 2.

FIG. 6 is a schematic diagram for describing a reflection device illustrated in FIG. 3A and the like.

FIG. 7 is a schematic diagram for describing a reflection device illustrated in FIG. 3A and the like.

FIG. 8 is a diagram for describing an example of a method of designing a surface shape of the diffuser plate illustrated in FIG. 3A and the like.

FIG. 9 is a diagram for describing the example of the method of designing the surface shape of the diffuser plate illustrated in FIG. 3A and the like.

FIG. 10 is a diagram for describing the example of the method of designing the surface shape of the diffuser plate illustrated in FIG. 3A and the like.

FIG. 11 is a diagram for describing the example of the method of designing the surface shape of the diffuser plate illustrated in FIG. 3A and the like.

FIG. 12 is a schematic plan view of an example of a configuration of a region-division wavelength selector illustrated in FIG. 1.

FIG. 13 is a schematic diagram for describing an aspect of yellow light and blue light output from a fluorescent substance region illustrated in FIG. 2.

FIG. 14 is a schematic diagram for describing an aspect of blue light output from a reflection region illustrated in FIG. 2.

FIG. 15 is an overview diagram illustrating a configuration example of a light source module according to a first modification of the present disclosure and a projector including the light source module.

FIG. 16 is an overview diagram illustrating a configuration example of a light source module according to a second modification of the present disclosure and a projector including the light source module.

FIG. 17 is a schematic plan view of an example of a configuration of a region-division wavelength selector illustrated in FIG. 15.

FIG. 18 is an overview diagram illustrating a configuration example of a light source module according to a third modification of the present disclosure and a projector including the light source module.

FIG. 19 is an overview diagram illustrating a configuration example of a light source module according to a fourth modification of the present disclosure and a projector including the light source module.

### MODES FOR CARRYING OUT THE INVENTION

Next, with reference to drawings, details of embodiments of the present disclosure will be described. The following description is a specific example of the present disclosure, and the present disclosure is not limited to the following embodiments. In addition, the present disclosure is not limited to placements, dimensions, dimensional ratios, and the like of respective structural elements in each diagram. It is to be noted that the description will be given in the following order.
1. Embodiment (example of light source module including reflection region that outputs blue light having annular angular distribution)
2. Modifications
2-1. First Modification (another example of configuration of light source module)
2-2. Second Modification (another example of configuration of light source module)
2-3. Third Modification (another example of configuration of light source module)
2-4. Fourth Modification (another example of configuration of light source module)

### 1. Embodiment

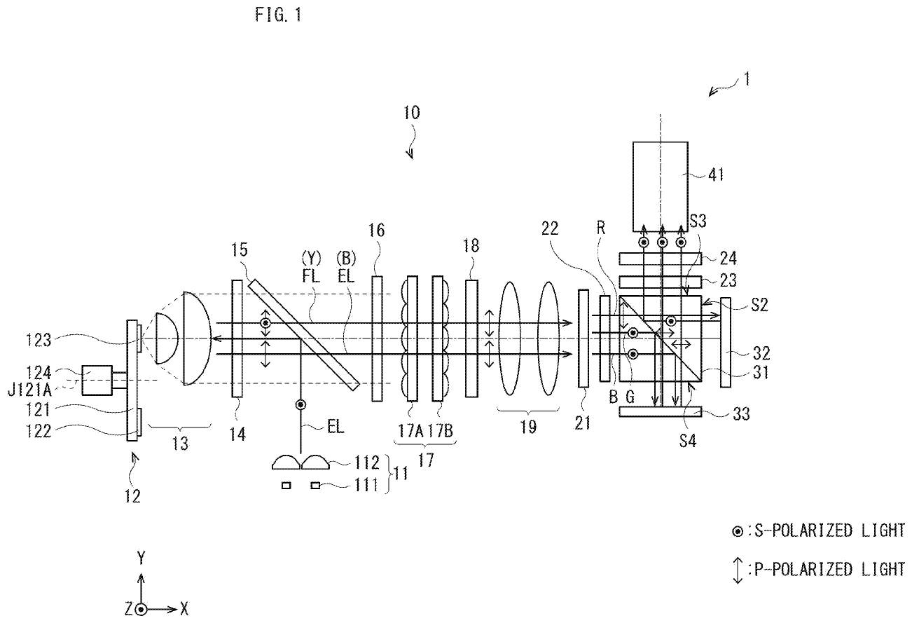

FIG. 1 illustrates a configuration example of a light source module (light source module 10) according to an embodiment of the present disclosure and a projector (projector 1) including the light source module. The projector 1 is a reflective 2LCD projection display device that performs light modulation by two reflective liquid-crystal panels (liquid-crystal displays (LCDs)).

The light source module 10 includes a light source section 11, a wavelength conversion section 12, and a region-division wavelength selector 16, for example. The light source module 10 further includes a condenser lens 13, a quarter-wave plate 14, a wavelength-selective PBS 15. lens arrays 17, a PS converter 18, relay lenses 19, polarizing plates 21 and 24, wavelength-selective polarization rotators 22 and 23, a polarization beam splitter (PBS) 31, a first light valve 32, a second light valve 33, and a projection lens 41.

The light source section 11 corresponds to a specific example of a “light source section” according to the present disclosure. The light source section 11 includes one or a plurality of light sources 111, and lenses 112 that are opposed to the respective light sources 111. For example, the light source 111 is a solid-state light source that emits light in a predetermined wavelength band for exciting fluorescent substance particles included in a fluorescent substance layer 122 (to be described later) of the wavelength conversion section 12. As the light source 111, it is possible to use a semiconductor laser (laser diode (LD)) that emits S-polarized or P-polarized light, for example. Alternatively, it is possible to use a light-emitting diode (LED).

For example, the light source section 11 emits excitation light EL that is S-polarized light (blue light B) in a wavelength band of 400 nm to 470 nm corresponding to blue. It is to be noted that, in the present specification, the light in a predetermined wavelength band refers to light having a luminous intensity peak in that wavelength band.

The wavelength conversion section 12 corresponds to a specific example of a “wavelength conversion section” according to the present disclosure. The wavelength conversion section 12 absorbs light (excitation light EL) that enters from the light source section 11, converts the absorbed light into light (fluorescent light FL) in a different wavelength band, and outputs the converted light. The wavelength conversion section 12 is a so-called reflective wavelength converter, and is configured to reflect and output the fluorescent light FL generated when the excitation light EL enters.

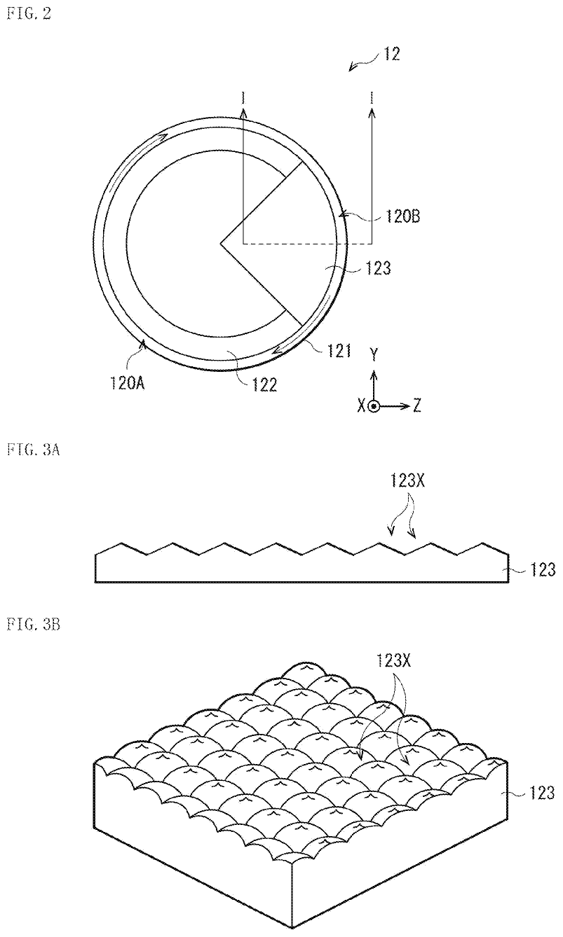

FIG. 2 schematically illustrates an example of a planar configuration of the wavelength conversion section 12. For example, the wavelength conversion section 12 includes a wheel substrate 121, a fluorescent substance layer 122, and a reflective polarization maintaining diffuser plate 123. As illustrated in FIG. 2, the wavelength conversion section 12 has a fluorescent substance region 120A and a reflection region 120B. The fluorescent substance region 120A includes the fluorescent substance layer 122. The reflection region 120B includes the polarization maintaining diffuser plate 123.

For example, the wavelength conversion section 12 is a so-called fluorescent substance wheel that is rotatable about a rotation axis (for example, axis J121A). A motor 124 (driving section) is coupled to a center of the wheel substrate 121 of the fluorescent substance wheel. The wheel substrate 121 is rotatable in a direction indicated by arrows illustrated in FIG. 2, for example, about the axis J121A by driving force of the motor 124. The fluorescent substance wheel includes the fluorescent substance layer 122 that is successive in a rotation circumferential direction of the wheel substrate 121, for example. In addition, the fluorescent substance wheel includes the polarization maintaining diffuser plate 123 that divides the successive fluorescent substance layer 122. When the wheel substrate 121 rotates, an irradiation position of the excitation light EL on the fluorescent substance wheel changes (moves) temporally at a speed depending on the number of rotations. This allows the wavelength conversion section 12 to output time-averaged white light that is temporal repetition of yellow, blue, yellow, blue, . . . , as illumination light.

The wheel substrate 121 supports the fluorescent substance layer 122 and the polarization maintaining diffuser plate 123. For example, the wheel substrate 121 is a disc-shaped plate-like member having a pair of surfaces that are opposed to each other. For example, the wheel substrate 121 functions as a reflective member and a heat release member. For example, the wheel substrate 121 may include metal material of high thermal conductivity. Alternatively, the wheel substrate 121 may include ceramic material or metal material that are able to undergo a mirror finish, for example. This makes it possible to suppress a rise in temperature of the fluorescent substance layer 122 and to improve an efficiency of extracting light (fluorescent light FL) by the wavelength conversion section 12.

The fluorescent substance layer 122 includes a plurality of fluorescent substance particles. The fluorescent substance layer 122 gets excited by the excitation light EL and outputs fluorescent light FL in a different wavelength band from a wavelength band of the excitation light EL. The fluorescent substance layer 122 is formed in a plate-like shape, and is configured by a so-called ceramic phosphor or a binder phosphor, for example. The fluorescent substance layer 122 is provided in the fluorescent substance region 120A on a surface 121S1 of the wheel substrate 121. For example, the fluorescent substance layer 122 includes fluorescent substance particles that gets excited by the blue light B emitted from the light source section 11 and outputs light (yellow light Y) in a wavelength band corresponding to yellow. Examples of such fluorescent substance particles include an yttrium-aluminum-garnet (YAG)-based material. The fluorescent substance layer 122 may further include semiconductor nanoparticles such as quantum dots, organic pigments, or the like.

The polarization maintaining diffuser plate 123 does not have a polarization action, but has light reflectivity and a diffusive action with respect to light (for example, blue light B) in a predetermined wavelength band. According to the present embodiment, this allows the wavelength conversion section 12 to output the excitation light EL as a portion (blue light B) of illumination light. For example, as illustrated in FIG. 2, the polarization maintaining diffuser plate 123 is provided in the reflection region 120B of the wheel substrate 121 and has a circle sector shape to fit the shape of the reflection region 120B.

FIG. 3A schematically illustrates an example of a cross-sectional shape of the polarization maintaining diffuser plate 123 taken along a line I-I illustrated in FIG. 2. FIG. 3B schematically illustrates a surface structure of the polarization maintaining diffuser plate 123 illustrated in FIG. 2. For example, the polarization maintaining diffuser plate 123 according to the present embodiment includes a plurality of reflection devices 123X with an inclined surface, the reflection devices 123X being arranged with no space therebetween. This allows the excitation light EL entering the reflection region 120B to get reflected by the respective inclined surfaces of the plurality of reflection devices 123X and exit from the reflection region 120B toward the condenser lens 13 as the blue light B having an annular angular distribution.

It is possible to control the angular distribution of the blue light B output from the reflection region 120B, on the basis of a surface shape of the polarization maintaining diffuser plate 123. Hereinafter, an example of a method of designing the surface shape of the polarization maintaining diffuser plate 123 will be described.

The surface shape of the polarization maintaining diffuser plate 123 may be designed in a most simplified way when assuming that parallel light enters the polarization maintaining diffuser plate 123. However, in practice, light condensed by the condenser lens 12 enters the polarization maintaining diffuser plate 123. Therefore, the surface shape thereof is designed while checking effects of the condensed light through simulation or the like and giving feedback.

There are countless examples of the surface shapes of the polarization maintaining diffuser plate 123 that reflects light into an annular shape. Therefore, it will be considered that the surface shape of the polarization maintaining diffuser plate 123 is formed by arranging a plurality of simple unit structures. Such a configuration makes it possible to reflect light into an annular shape even if the plurality of unit structures are arranged as long as the unit structure has a shape that makes it possible to reflect light in an annular angular distribution. In other words, for the surface shape of the polarization maintaining diffuser plate 123, it is sufficient to design the unit structure that reflects light in an annular angular distribution.

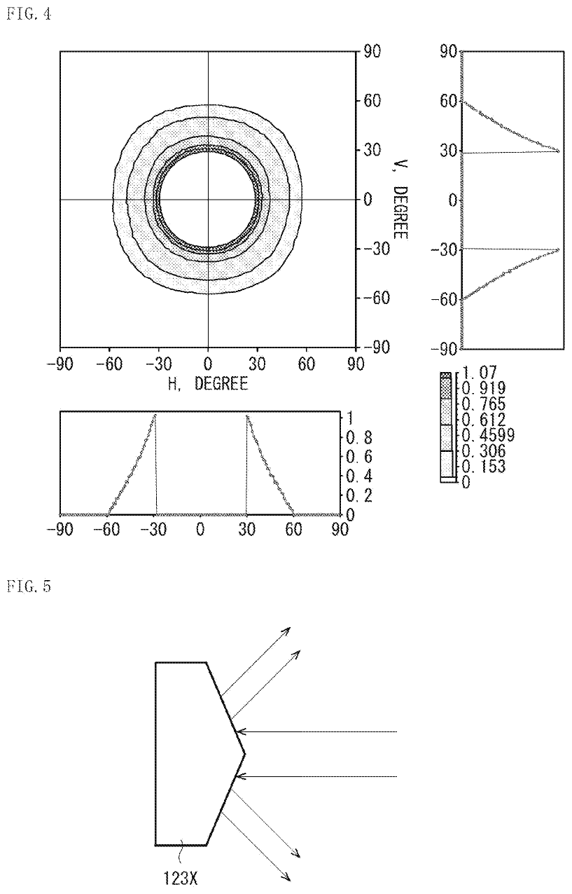

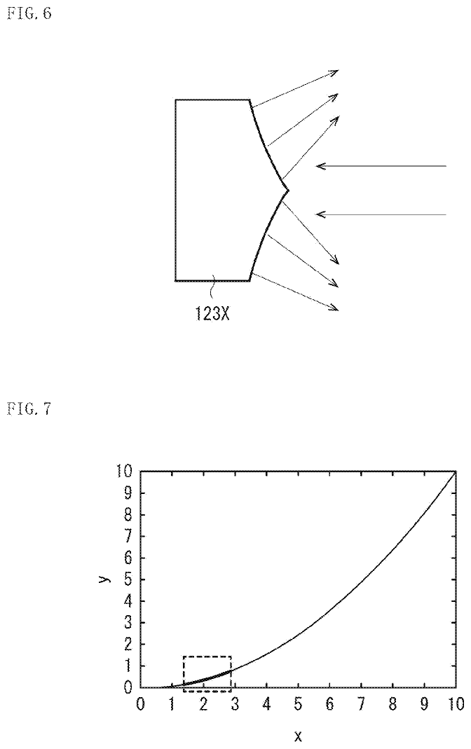

As an example, the surface shape may be a conical shape as illustrated in FIG. 5, in a case where the parallel light enters a unit structure that reflects light into a range of 30° to ˜60° but does not reflect light into a range of 0° to 30° with respect to a front direction, as illustrated in FIG. 4. It is to be noted that a simple cone is able to reflect light only at a certain angle. To reflect light at various angles, it is considered that the cone has a concave-curved lateral surface as illustrated in FIG. 6, for example. When the cone has the concave-curved lateral surface, light gets reflected in a predetermined angular range. In other words, by setting the lateral surface of the cone to an appropriate curved surface, it is possible to obtain a shape that reflects light at annular angles.

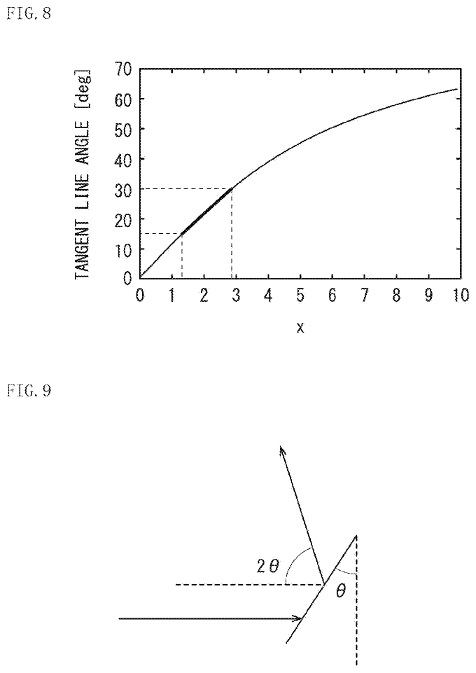

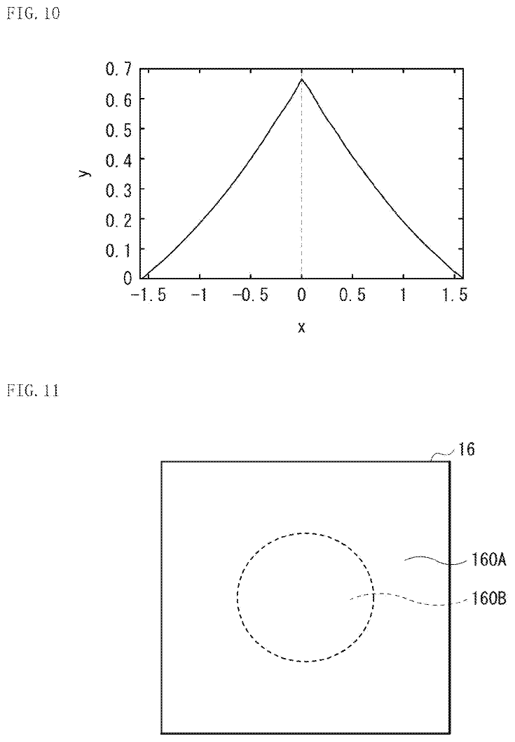

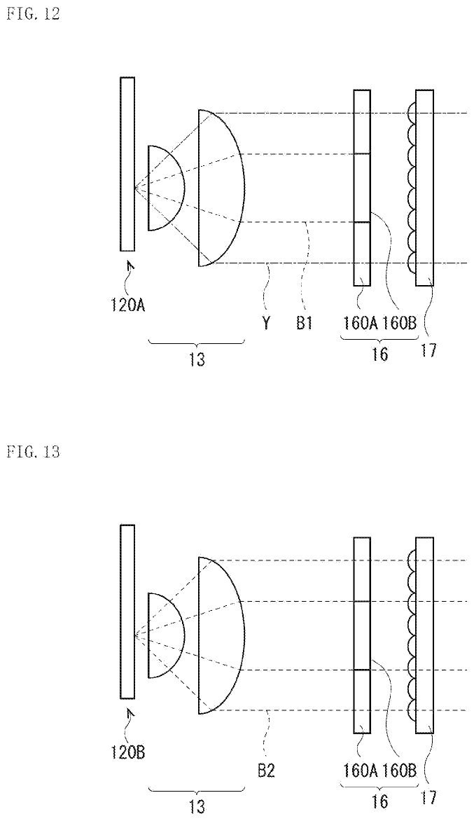

First, an appropriate curve for the lateral surface of the cone is considered. Theoretically, there are countless examples of the curve that achieves desired angular characteristics. Here, for example, it is considered to use a most simple curve of a quadratic function as illustrated in FIG. 7. FIG. 7 illustrates a graph of y=(1/10) x². FIG. 8 illustrates tangent line angles corresponding to the curve of y=(1/10) x². The tangent line angles are obtained through differentiation of the curve. As illustrated in FIG. 9, light is reflected at an angle of 2×θ by an inclined surface having an angle θ. Therefore, to reflect the light into the range of 30° to 60°, it is necessary to select a curve having an angle in a range of 15° to 30°. Specifically, a corresponding distance (for example, a zone enclosed by dashed lines in FIG. 7) is clipped from the graph and the clipped curve is adopted. As illustrated in FIG. 10, a cross section of the lateral surface of the cone is obtained by coupling the curve clipped from the graph illustrated in FIG. 7 and a curve obtained by reversing the curve into an X direction. By three-dimensionalizing it, it is possible to obtain the unit structure that reflects light into the range of 30° to ˜60° but does not reflect light into the range of 0° to 30° with respect to the front direction.

It is to be noted that the above-described design method assumes that incident light is parallel light. Therefore, sometimes a value deviated from a target value is obtained in a case where incident light is light condensed by a lens or the like. In this case, in principle, the value changes as if the annular shape swells. Therefore, a design value is preferably decided in consideration of effects thereof. In addition, the unit structure desirably has a size that is smaller than a spot size of incident light at least. One reason for this is that a designed angular distribution is not obtained if light enters only a portion of the unit structure.

The condenser lens 13 includes one or a plurality of lenses. The condenser lens 13 is disposed between the wavelength conversion section 12 and the quarter-wave plate 14. The condenser lens 13 condenses the excitation light EL into a predetermined spot diameter, lets the condensed light enter the wavelength conversion section 12, converts the fluorescent light FL output from the wavelength conversion section 12 into parallel light, and guides the light to the quarter-wave plate 14.

The quarter-wave plate 14 converts linearly polarized light into circularly polarized light and outputs the circularly polarized light. The quarter-wave plate 14 is disposed between the condenser lens 13 and the wavelength-selective PBS 15.

The wavelength-selective PBS 15 separates light of a predetermined wavelength band on the basis of its polarization direction. The wavelength-selective PBS 15 selectively reflects S-polarized blue light B, for example. The wavelength-selective PBS 15 is disposed between the quarter-wave plate 14 and the region-division wavelength selector 16, and is opposed to the light source section 11. This makes it possible to reflect S-polarized excitation light EL emitted from the light source section 11, toward the wavelength conversion section 12.

The region-division wavelength selector 16 has a region that selectively reflects or absorbs light in a predetermined wavelength band, in its plane. FIG. 11 schematically illustrates an example of a configuration of the region-division wavelength selector 16. For example, the region-division wavelength selector 16 has a transmission region 160A and a wavelength selection region 160B. The transmission region 160A corresponds to a specific example of a “first region” according to the present disclosure, and transmits both yellow light Y and blue light B, for example.

The wavelength selection region 160B corresponds to a specific example of a “second region” according to the present disclosure. The wavelength selection region 160B selectively reflects or absorbs the blue light B. For example, the wavelength selection region 160B is provided on an optical path for the excitation light EL (blue light B1) output from the fluorescent substance region 120A of the wavelength conversion section 12.

As a whole, the lens array 17 has a function of smoothing the incident light that enters the first light valve 32 and the second light valve 33 in a manner that homogeneous luminance distribution is obtained. The lens array 17 includes a first fly-eye lens 17A and a second fly-eye lens 17B. The first fly-eye lens 17A includes a plurality of two-dimensionally arrayed micro lenses. The second fly-eye lens 17B includes a plurality of micro lenses arrayed in a manner that the respective micro lenses correspond to the micro lenses included in the first fly-eye lens 17A. The lens array 17 is disposed between the region-division wavelength selector 16 and the PS converter 18.

The PS converter 18 aligns polarization states of incident light into one direction and outputs the light. For example, the projector 1 transmits P-polarized light without any change, but converts S-polarized light into P-polarized light. The PS converter 18 is disposed between the lens array 17 and the relay lens 19. Illumination light passed though the PS converter 18 is guided to the polarizing plate 21 via the relay lenses 19.

The polarizing plates 21 and 24 only transmits linearly polarized light in respective specific directions. In the projector 1, the polarizing plate 21 only transmits P-polarized light. The polarizing plate 24 only transmits S-polarized light. The polarizing plate 21 is disposed between the relay lens 19 and the wavelength-selective polarization rotator 22. The polarizing plate 24 is disposed between the wavelength-selective polarization rotator 22 and the projection lens 41.

The wavelength-selective polarization rotators 22 and 23 selectively rotates and output polarized light in respective predetermined wavelength bands. The wavelength-selective polarization rotator 22 is disposed between the polarizing plate 21 and a first surface S1 of the PBS 31. The wavelength-selective polarization rotator 23 is disposed between a third surface S3 of the PBS 31 and the polarizing plate 24. For example, among illumination light (P-polarized light) that enters from the polarizing plate 21, the wavelength-selective polarization rotator 22 transmits light (red light R) in a wavelength band corresponding to red without any change, but converts light (green light G) in a wavelength band corresponding to green and light (blue light B) in a wavelength band corresponding to blue into S-polarized light and outputs the S-polarized light toward the PBS 31. For example, the wavelength-selective polarization rotator 23 transmits red light R (S-polarized light) output from the third surface S3 of the PBS 31 without any change, but converts green light G (P-polarized light) and blue light B (P-polarized light) into S-polarized light and outputs the S-polarized light toward the polarizing plate 24.

The PBS 351 separates incident light on the basis of its polarized components. For example, the PBS 31 includes an optical functional film and two prisms. The optical functional film reflects or transmits incident light depending on its polarized components. The two prisms are bonded with the optical functional film interposed therebetween. For example, the PBS 31 of the projector 1 is configured to reflect an s-polarized component and transmit a p-polarized component. The PBS has four surfaces (first surface S1, second surface S2, third surface S3, and fourth surface S4), for example. With regard to the four surfaces, the first surface S1 and the second surface S2 are opposed to each other with the optical functional film interposed therebetween. The third surface S3 and the fourth surface S4 are opposed to each other with the optical functional film interposed therebetween. In addition, the third surface S3 and the fourth surface S4 are disposed between the first surface S1 and the second surface S2 as surfaces adjacent to the first surface S1 and the second surface S2. In the present embodiment, the first surface S1 serves as an entrance surface of illumination light, and the third surface S3 serves as an output surface of the illumination light. The first surface S1 is opposed to the wavelength-selective polarization rotator 22, and the third surface S3 is opposed to the wavelength-selective polarization rotator 23.

Each of the first light valve 32 and the second light valve 33 modulates incident light, and outputs modulated light. For example, the first light valve 32 and the second light valve 33 modulate illumination light on the basis of a picture signal, and output the modulated illumination light. For example, the first light valve 32 is opposed to the second surface S2 of the PBS 31. For example, the second light valve 33 is opposed to the fourth surface S4 of the PBS 31. In the present embodiment, the first light valve 32 and the second light valve 33 includes reflective liquid crystal, for example. This allows light entering the first light valve 32 and the second light valve 33 to change into polarized light that is orthogonal to incident polarized light, and exit.

The projection lens 41 includes one or a plurality of lenses. The projection lens 41 is disposed downstream of the polarizing plate 24. The projection lens 41 projects light modulated by the first light valve 32 and the second light valve 33 onto a screen (not illustrated) or the like as picture light to form an image.

### [Principle of Operation of Light Source Module]

In the present embodiment, the light source section 11 emits the blue light B as the excitation light EL toward a Y-axis direction, for example. The blue light B principally includes S-polarized light. The excitation light EL emitted from the light source section 11 is reflected by the wavelength-selective PBS 15 toward the wavelength conversion section 12, for example, toward an X-axis direction. The excitation light EL reflected by the wavelength-selective PBS 15 first enters quarter-wave plate 14. The quarter-wave plate 14 converts the polarization direction of the excitation light EL from an S-polarized direction into a circularly polarized direction, and outputs the converted light toward the condenser lens 13. The excitation light EL entering the condenser lens 13 gets condensed into a predetermined spot diameter, and exits toward the wavelength conversion section 12.

The excitation light EL entering the wavelength conversion section 12 excites fluorescent substance particles included in a fluorescent substance layer 122. The fluorescent substance particles in the fluorescent substance layer 122 gets excited by irradiation with the excitation light EL, and emits fluorescent light FL. The fluorescent light FL is non-polarized yellow light Y including an S-polarized component and a P-polarized component, and exits toward the condenser lens 13. In addition, the excitation light EL entering the wavelength conversion section 12 exits from (gets reflected by) the polarization maintaining diffuser plate 123 toward the condenser lens 13 while maintaining its polarization direction. As described above, when the wheel substrate 121 rotates, an irradiation position of the excitation light EL changes (moves) temporally at a speed depending on the number of rotations. This allows the wavelength conversion section 12 to output time-averaged white light that is temporal repetition of yellow, blue, yellow, blue, . . . , as illumination light.

The excitation light EL and the fluorescent light FL output from the wavelength conversion section 12 get converted into substantially parallel light beams and exit toward the quarter-wave plate 14. The fluorescent light FL entering the quarter-wave plate 14 exits toward the wavelength-selective PBS 15 still in the non-polarized state. The polarization direction of the excitation light EL entering the quarter-wave plate 14 gets converted from a circularly polarized direction into a P-polarized direction, and the excitation light EL exits toward the wavelength-selective PBS 15. The excitation light EL and the fluorescent light FL output from the quarter-wave plate 14 pass through the wavelength-selective PBS 15 and enters the region-division wavelength selector 16.

FIG. 12 schematically illustrates an aspect of excitation light EL (blue light B1) and fluorescent light FL (yellow light Y) output from the fluorescent substance region 120A of the wavelength conversion section 12. FIG. 13 schematically illustrates an aspect of blue light B2 output from the reflection region 120B of the wavelength conversion section 12.

Among light (illumination light) output from the wavelength conversion section 12, the fluorescent light FL (yellow light Y) that has been output from the fluorescent substance region 120A and entered the region-division wavelength selector 16 passes through the transmission region 160A including the wavelength selection region 160B and toward the lens array 17. Among the light (illumination light) output from the wavelength conversion section 12, the excitation light EL (blue light B1) that has been output from the fluorescent substance region 120A gets reflected by the wavelength selection region 160B toward the wavelength conversion section 12.

Meanwhile, among the light (illumination light) output from the wavelength conversion section 12, the excitation light EL (blue light B2) that has been output from the reflection region 120B exits, for example, in an annular angular distribution as described above. In other words, the excitation light EL (blue light B2) that has been output from the reflection region 120B enters the transmission region 160A and exits toward the lens array 17 while avoiding the wavelength selection region 160B of the region-division wavelength selector 16.

As described above, the blue light B1 output from the fluorescent substance region 120A and the blue light B2 output from the reflection region 120B exits in different angular distributions. This allows the region-division wavelength selector 16 to spatially separate the blue light B1 from the blue light B2.

The illumination light (yellow light Y and blue light B2) output from the region-division wavelength selector 16 passes through the lens array 17 toward the PS converter 18. The PS converter 18 converts S-polarized components of the fluorescent light FL that has passed through the region-division wavelength selector 16 into P-polarized components and outputs the converted fluorescent light FL, but outputs P-polarized excitation light EL without any change. This makes it possible to align polarization states of illumination light into a P-polarized state.

Illumination light output from the PS converter 18 is guided to the polarizing plate 21 via the relay lenses 19. The polarizing plate 21 blocks polarized components other than the P-polarized components included in the illumination light, and outputs only the P-polarized components toward the wavelength-selective polarization rotator 22.

Among the illumination light that enters from the polarizing plate 21, the wavelength-selective polarization rotator 22 transmits light (red light R) in a wavelength band corresponding to red as P-polarized light without any change, but converts light (green light G) in a wavelength band corresponding to green and light (blue light B) in a wavelength band corresponding to blue into S-polarized light and outputs the S-polarized light toward the first surface S1 of the PBS 31. The PBS 31 separates the red light R, green light G, and blue light B output from the wavelength-selective polarization rotator 22, on the basis of their polarization directions. Specifically, the red light R that is P-polarized light passes through the optical functional film and gets guided to the first light valve 32 that is opposed to the second surface S2 of the PBS 31. The green light G and the blue light B that are S-polarized light get reflected by the optical functional film and get guided to the second light valve 33 that is opposed to the fourth surface S4 of the PBS 31.

The red light R entering the first light valve 32 gets modulated on the basis of a picture signal, the polarization direction of the red light R gets converted from the P-polarized direction to the S-polarized direction. The converted red light R exits toward the PBS 31, gets reflected by the optical functional film of the PBS 31, and exits from the third surface S3 toward the wavelength-selective polarization rotator 22. The green light G and blue light B entering the second light valve 33 gets modulated on the basis of a respective picture signals, the polarization directions thereof gets converted from S-polarized directions to P-polarized directions. The converted green light G and blue light B exits toward the PBS 31, passes through an optical thin film, and exits from the third surface S3 toward the wavelength-selective polarization rotator 22.

Among the red light R, green light G, blue light B that enters from the PBS 31, the wavelength-selective polarization rotator 23 transmits the S-polarized red light R without any change, but converts the P-polarized green light G and the P-polarized blue light B into P-polarized light and outputs the P-polarized light toward the polarizing plate 24. The polarizing plate 24 blocks polarized components other than the P-polarized components included in the red light R, green light G, blue light B, and outputs only the P-polarized components toward the projection lens 41. This makes it possible to project a high-contrast picture with wide color gamut.

It is to be noted that, although FIG. 1 illustrates the example in which the PS converter 18 outputs illumination light whose polarization states are aligned into a P-polarized state, but the present disclosure is not limited thereto. The PS converter 18 may output illumination light whose polarization states are aligned into an S-polarized state. In this case, for example, the wavelength-selective polarization rotator 22 converts red light R from S-polarized light into P-polarized light, but green light G and blue light B passes through the wavelength-selective polarization rotator 22 still in S-polarized states. This allows the red light R to pass through the optical functional film of the PBS and get guided to the first light valve 32 that is opposed to the second surface S2 of the PBS 31. The green light G and the blue light B get reflected by the optical functional film and get guided to the second light valve 33 that is opposed to the fourth surface S4 of the PBS 31.

### [Actions and Effects]

The light source module 10 according to the present embodiment is configured in such a manner that the wavelength conversion section 12 has the fluorescent substance region 120A of absorbing excitation light EL and outputting fluorescent light FL (yellow light Y) and the reflection region 120B of reflecting the excitation light EL and outputting the blue light (blue light B2), and the reflection region 120B outputs the blue light B2 in a different angular distribution from blue light B (blue light B1) output from the fluorescent substance region 120A together with the fluorescent light FL (yellow light Y). In addition, the light source module 10 further includes the region-division wavelength selector 16 having the transmission region 160A and the wavelength selection region 160B, the transmission region 160A transmitting the yellow light Y and the blue light B, the wavelength selection region 160B reflecting or absorbing the blue light B selectively. This makes it possible to spatially separate the blue light B1 output from the fluorescent substance region 120A from the blue light B2 output from the reflection region 120B. A description thereof will be provided below.

In recent years, compact high-luminance projectors have been desired. To achieve such a compact high-luminance projector, it is important to develop an optical component with high light use efficiency.

With regard to a two-chip projector, it is possible to achieve a compact two-chip projector by using a reflective split fluorescent substance wheel as a light source. The reflective split fluorescent substance wheel has two regions including an yellow region and a blue region that supply respective color light beams (yellow light Y and blue light B) to an illumination optical system in a time-sequential manner. However the use of the reflective split fluorescent substance wheel causes a phenomenon that blue light B′ appears in the time for the yellow light due to a scattering phenomenon by fluorescent substance particles or surface reflection on the fluorescent substance wheel. It is difficult to separate this blue light B′ because the blue light B′ uses the same optical path and has the same non-polarized state as the yellow light Y, and the blue light B′ has the same wavelength as the blue light B in the time for blue light.

Mixing of blue light with red light or green light causes reduction in the color gamut. In particular, for reasons of luminous efficiency function, influence of blue light mixed with red light is more than twice as great as influence of blue light mixed with green light. This drastically deteriorates color gamut and color reproducibility.

On the other hand, according to the present embodiment, the reflection region 120B of the wavelength conversion section 12 outputs the blue light B2 in a different angular distribution from blue light B (blue light B1) output from the fluorescent substance region 120A together with the fluorescent light FL (yellow light Y). In addition, the light source module 10 includes the region-division wavelength selector 16 having the transmission region 160A and the wavelength selection region 160B, the transmission region 160A transmitting the yellow light Y and the blue light B, the wavelength selection region 160B reflecting or absorbing the blue light B selectively. This makes it possible to spatially separate the blue light B1 from the blue light B2, and it becomes possible to selectively remove the blue light B (blue light B1) output from the fluorescent substance region 120A together with the fluorescent light FL (yellow light Y).

As described above, it is possible for the light source module 10 according to the present embodiment to widen the color gamut of the projector 1 including the light source module 10. In other words, it is possible to achieve the compact high-luminance projector 1 having high color reproducibility.

In addition, since the region-division wavelength selector 16 of the light source module 10 according to the present embodiment has the wavelength selection region 160B that has a reflective function, the wavelength selection region 160B reflects excitation light EL (blue light B1) output from the fluorescent substance region 120A together with the fluorescent light FL (yellow light Y), and the reflected excitation light EL enters the wavelength conversion section 12 again. This makes it possible to improve use efficiency of the excitation light EL.

Next, first to fourth modifications of the embodiment of the present disclosure will be described. Hereinafter, structural elements that are similar to the above-described embodiment will be denoted with the same reference signs as the above-described embodiment, and repeated description will be appropriately omitted.

### 2. Modifications

### (2-1. First Modification)

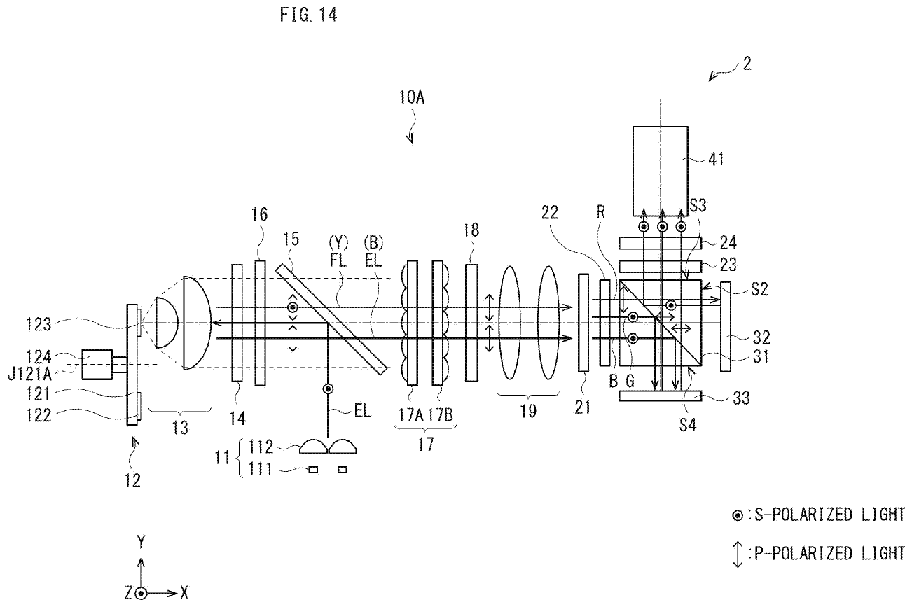

FIG. 14 illustrates a configuration example of a light source module 10A according to a first modification of the present disclosure and a projector 2 including the light source module 10A. In the above-described embodiment, the region-division wavelength selector 16 is disposed between the wavelength-selective PBS 15 and the lens array 17, but the present disclosure is not limited thereto. For example, as illustrated in FIG. 14, the region-division wavelength selector 16 may be disposed between the quarter-wave plate 14 and the wavelength-selective PBS 15. Even in such a configuration, it is possible to achieve effects that are similar to the above-described embodiment.

### (2-2. Second Modification)

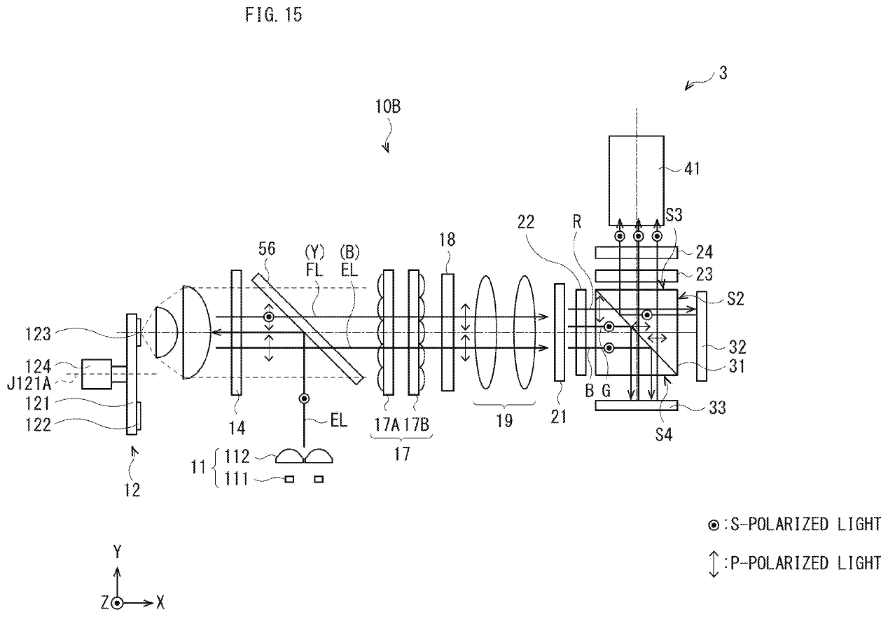

FIG. 15 illustrates a configuration example of a light source module 10B according to a second modification of the present disclosure and a projector 3 including the light source module 10B. The wavelength-selective PBS 15 may be integrated with the region-division wavelength selector 16. The light source module 10B according to the present modification is different from the above-described embodiment in that a region-division wavelength selector 56 has the function of the wavelength-selective PBS and is disposed between the quarter-wave plate 14 and the lens array 17 in such a manner that the region-division wavelength selector 56 is opposed to the light source section 11.

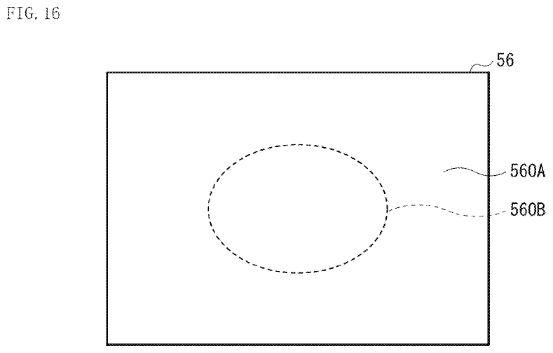

FIG. 16 schematically illustrates an example of a configuration of the region-division wavelength selector 56. For example, the region-division wavelength selector 56 has a transmission region 560A and a wavelength selection region 560B. For example, the transmission region 560A is configured to selectively reflect blue light B in one polarization state (for example, S-polarized state) and transmit blue light B in the other polarization state (for example, P-polarized state). For example, the wavelength selection region 560B is provided on an optical path for excitation light EL (blue light B1) output from the fluorescent substance region 120A of the wavelength conversion section 12, and is configured to selectively reflect both the blue light B in the S-polarized state and the blue light B in the P-polarized state.

As described above, the present modification uses the region-division wavelength selector 56 having the function of wavelength-selective PBS. This makes it possible to reduce the number of components included in the light source module 10B. This makes it possible to reduce its manufacturing cost.

### (2-3. Third Modification)

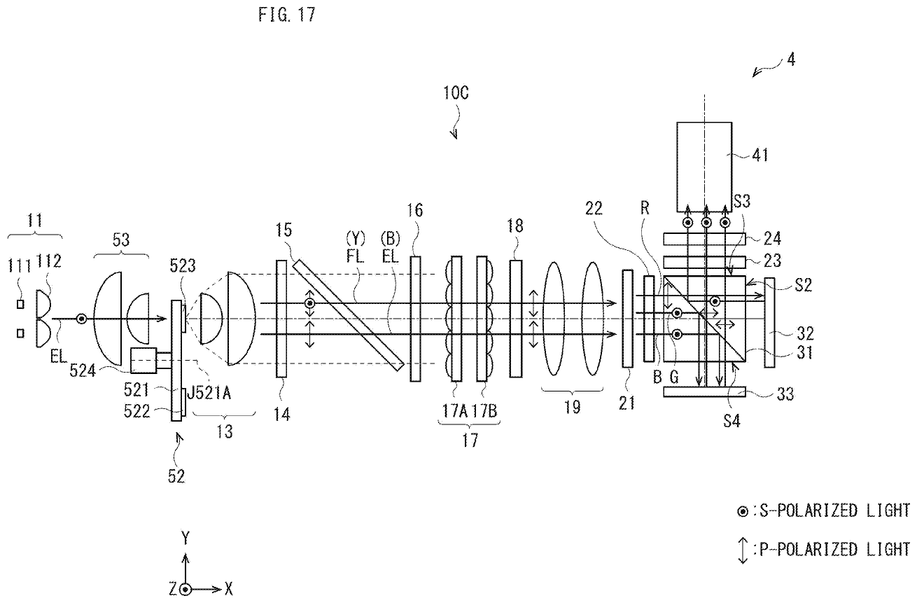

FIG. 17 illustrates a configuration example of a light source module 10C according to a third modification of the present disclosure and a projector 4 including the light source module 10C. The above-described embodiment uses the reflective wavelength conversion section 12. However, the present disclosure is not limited thereto. The present technology is applicable to a transmissive wavelength conversion section 52.

The wavelength conversion section 52 is a so-called transmissive wavelength converter, and is configured to let fluorescent light FL generated when excitation light EL enters exit from an opposite side from an incident side of the excitation light EL. For example, the wavelength conversion section 52 includes a wheel substrate 521, a fluorescent substance layer 522, a transmissive polarization maintaining diffuser plate 52, and a motor 524. The wheel substrate 521 has optical transparency. In the present modification, the light source section 11 is disposed behind a back surface side of the wheel substrate 521. A condenser lens 53 is disposed between the light source section 11 and the wavelength conversion section 52.

### (2-4. Fourth Modification)

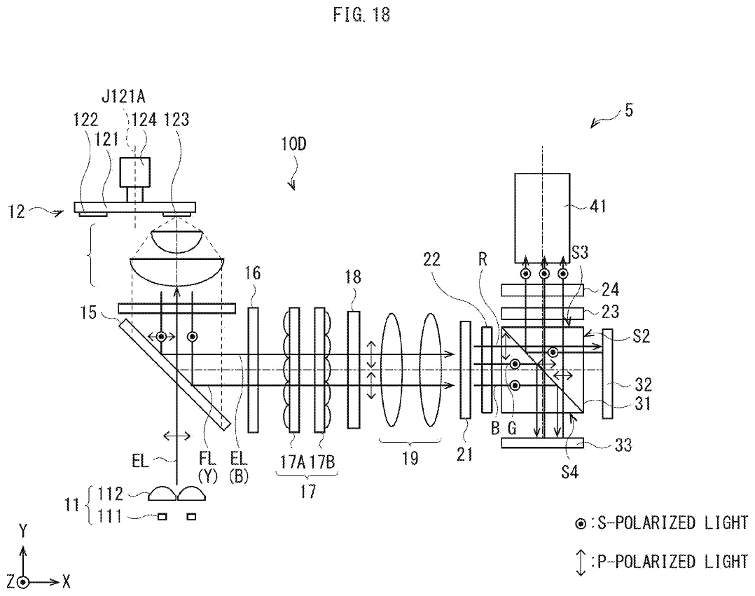

FIG. 18 illustrates a configuration example of a light source module 10D according to a fourth modification of the present disclosure and a projector 4 including the light source module 10D.

In the above-described embodiment, structural elements are disposed in such a manner that, in the wavelength-selective PBS 15, excitation light EL emitted from the light source section 11 is orthogonal to fluorescent light FL output from the wavelength conversion section 15, for example. However, the present disclosure is not limited thereto. As illustrated in FIG. 18, the present modification is different from the above-described embodiment in that the light source section 11 and the wavelength conversion section 12 are disposed on a straight line in such a manner that the light source section 11 is opposed to the wavelength conversion section 12.

For example, the light source module 10D according to the present modification includes the light source section 11 and the wavelength-selective PBS 15. The light source section 11 emits excitation light EL that is blue light B principally including P-polarized light. The wavelength-selective PBS 15 selectively transmits the P-polarized blue light B. In the light source module 10D, excitation light EL (blue light B) and fluorescent light FL (yellow light FL) output from the wavelength conversion section 12 gets reflected by the wavelength-selective PBS 15 and enters the region-division wavelength selector 15, for example.

As described above, in the present modification, the light source section 11 and the wavelength conversion section 12 are disposed on the straight line. This makes it easier to cool the light source section 11 and the wavelength conversion section 12 than the light source module 10 according to the above-described embodiment. Therefore, it becomes possible to reduce noise in a picture projected by the projector 5 including the light source module 10D. In addition, it is possible to achieve the smaller light source module 10D and a projector including the smaller light source module 10D.

The embodiment and first to fourth modifications have been described above. However, the present technology is not limited thereto, and various kinds of modifications thereof can be made. For example, each of the components of the optical system exemplified in the foregoing embodiment and the like, the arrangement thereof, the number thereof, and the like are mere examples. It is not necessary to include all of the components, or other components may be further included.

In addition, the light source modules 10 according to the present disclosure are applicable to devices other than the projector. For example, the light source modules 10 according to the present disclosure may be used for illumination, and are applicable to a light source for a headlight of an automobile or a light source for illumination, for example.

It is to be noted that the effects described herein are only for illustrative purposes and there may be other effects.

The present technology may be configured as follows. According to the present technology configured as follows, the wavelength conversion section has the fluorescent substance region of absorbing excitation light and outputting fluorescent light as first light and the reflection region of reflecting the excitation light and outputting the reflected light as second light, and the wavelength conversion section outputs second light from the reflection region in a different angular distribution from second light output from the fluorescent substance region together with the first light. In addition, the light source module includes the region-division wavelength selector having the first region and the second region, the first region transmitting the first light and the second light, the second region reflecting or absorbing the second light selectively. This makes it possible to selectively remove the second light output from the fluorescent substance region together with the first light. Therefore, it becomes possible to widen its color gamut.
(1)

A light source module including:
a light source section that emits excitation light;
a wavelength conversion section that outputs first light and second light that are in mutually different wavelength bands;
a fluorescent substance region that absorbs the excitation light and outputs the first light together with the second light, the first light being fluorescent light in a different wavelength band from the excitation light, the fluorescent substance region being provided in the wavelength conversion section;
a reflection region that outputs the excitation light as the second light in a different angular distribution from the second light output from the fluorescent substance region, the reflection region being provided in the wavelength conversion section; and
a region-division wavelength selector including a first region and a second region, the first region transmitting the first light and the second light, the second region reflecting or absorbing the second light selectively.
(2)

The light source module according to (1), in which the reflection region includes a plurality of reflection devices with an inclined surface, the reflection devices being arranged with no space therebetween.
(3)

The light source module according to (2), in which the inclined surface of each of the plurality of reflection devices has a substantially conical shape.
(4)

The light source module according to (3), in which a cross section of the inclined surface has a concave curved shape.
(5)

The light source module according to any one of (1) to (4), in which the second light output from the reflection region has an annular angular distribution.
(6)

The light source module according to any one of (2) to (5), in which each of the plurality of reflection devices reflects light into an annular shape.
(7)

The light source module according to any one of (1) to (6), further including:
an integrator disposed on optical paths for the first light and the second light that are output from the wavelength conversion section; and
a wavelength-selective polarization splitter that splits the second light on a basis of polarization directions, the wavelength-selective polarization splitter being disposed between the wavelength conversion section and the integrator.
(8)

The light source module according to (7), in which the region-division wavelength selector is disposed between the wavelength-selective polarization splitter and the integrator.
(9)

The light source module according to (7), in which the region-division wavelength selector is disposed between the wavelength conversion section and the wavelength-selective polarization splitter.
(10)

The light source module according to (7), in which the region-division wavelength selector and the wavelength-selective polarization splitter are integrated.
(11)

The light source module according to any one of (1) to (10), in which
the wavelength conversion section has a first surface and a second surface that are opposed to each other,
the wavelength conversion section includes a wheel substrate, a fluorescent substance layer, and a light diffusion structure,
the wheel substrate is rotatable about a rotation axis,
the fluorescent substance layer includes a plurality of fluorescent substance particles and is provided on the first surface in the fluorescent substance region, and
the light diffusion structure is provided on the first surface in the reflection region.
(12)

The light source module according to (11), in which the wheel substrate has light reflectivity.
(13)

The light source module according to (11), in which the wheel substrate has optical transparency.
(14)

The light source module according to any one of (11) to (13), in which the light source section is disposed on the second surface side of the wheel substrate.
(15)

The light source module according to any one of (7) to (14), in which the light source section and the wavelength conversion section are opposed to each other with the wavelength-selective polarization splitter interposed therebetween.
(16)

The light source module according to any one of (7) to (15), further including
a quarter-wave plate that rotates polarization directions of the excitation light, the first light, and the second light, the first light and the second light being output from the wavelength conversion section, the quarter-wave plate being disposed between the wavelength-selective polarization splitter and the wavelength conversion section.
(17)

A projector that includes a light source module, the light source module including:
a light source section that emits excitation light;
a wavelength conversion section that outputs first light and second light that are in mutually different wavelength bands;
a fluorescent substance region that absorbs the excitation light and outputs the first light together with the second light, the first light being fluorescent light in a different wavelength band from the excitation light, the fluorescent substance region being provided in the wavelength conversion section;
a reflection region that outputs the excitation light as the second light in a different angular distribution from the second light output from the fluorescent substance region, the reflection region being provided in the wavelength conversion section; and
a region-division wavelength selector including a first region and a second region, the first region transmitting the first light and the second light, the second region reflecting or absorbing the second light selectively.

The present application claims the benefit of Japanese Priority Patent Application JP2021-142353 filed with the Japan Patent Office on Sep. 1, 2021, the entire contents of which are incorporated herein by reference.

It should be understood by those skilled in the art that various modifications, combinations, sub-combinations and alternations may occur depending on design requirements and other factors insofar as they are within the scope of the appended claims or the equivalents thereof.

What is claimed is:

1. A light source module, comprising:
a light source section that emits excitation light;
a wavelength conversion section that outputs first light and second light that are in mutually different wavelength bands;
a fluorescent substance region that absorbs the excitation light and outputs the first light together with the second light, the first light being fluorescent light in a different wavelength band from the excitation light, the fluorescent substance region being provided in the wavelength conversion section;
a reflection region that outputs the excitation light as the second light in a different angular distribution from the second light output from the fluorescent substance region, the reflection region being provided in the wavelength conversion section; and
a region-division wavelength selector including a first region and a second region, the first region transmitting the first light and the second light, the second region reflecting or absorbing the second light selectively.

2. The light source module according to claim 1, wherein the reflection region includes a plurality of reflection devices with an inclined surface, the reflection devices being arranged with no space therebetween.

3. The light source module according to claim 2, wherein the inclined surface of each of the plurality of reflection devices has a substantially conical shape.

4. The light source module according to claim 3, wherein a cross section of the inclined surface has a concave curved shape.

5. The light source module according to claim 1, wherein the second light output from the reflection region has an annular angular distribution.

6. The light source module according to claim 2, wherein each of the plurality of reflection devices reflects light into an annular shape.

7. The light source module according to claim 1, further comprising:
an integrator disposed on optical paths for the first light and the second light that are output from the wavelength conversion section; and
a wavelength-selective polarization splitter that splits the second light on a basis of polarization directions, the wavelength-selective polarization splitter being disposed between the wavelength conversion section and the integrator.

8. The light source module according to claim 7, wherein the region-division wavelength selector is disposed between the wavelength-selective polarization splitter and the integrator.

9. The light source module according to claim 7, wherein the region-division wavelength selector is disposed between the wavelength conversion section and the wavelength-selective polarization splitter.

10. The light source module according to claim 7, wherein the region-division wavelength selector and the wavelength-selective polarization splitter are integrated.

11. The light source module according to claim 1, wherein
a the wavelength conversion section has a first surface and a second surface that are opposed to each other,
a the wavelength conversion section includes a wheel substrate, a fluorescent substance layer, and a light diffusion structure,
a the wheel substrate is rotatable about a rotation axis,
a the fluorescent substance layer includes a plurality of fluorescent substance particles and is provided on the first surface in the fluorescent substance region, and
a the light diffusion structure is provided on the first surface in the reflection region.

12. The light source module according to claim 11, wherein the wheel substrate has light reflectivity.

13. The light source module according to claim 11, wherein the wheel substrate has optical transparency.

14. The light source module according to claim 11, wherein the light source section is disposed on the second surface side of the wheel substrate.

15. The light source module according to claim 7, wherein the light source section and the wavelength conversion section are opposed to each other with the wavelength-selective polarization splitter interposed therebetween.

16. The light source module according to claim 7, further comprising
a a quarter-wave plate that rotates polarization directions of the excitation light, the first light, and the second light, the first light and the second light being output from the wavelength conversion section, the quarter-wave plate being disposed between the wavelength-selective polarization splitter and the wavelength conversion section.

17. A projector that includes a light source module, the light source module comprising:
a light source section that emits excitation light;
a wavelength conversion section that outputs first light and second light that are in mutually different wavelength bands;
a fluorescent substance region that absorbs the excitation light and outputs the first light together with the second light, the first light being fluorescent light in a different wavelength band from the excitation light, the fluorescent substance region being provided in the wavelength conversion section;
a reflection region that outputs the excitation light as the second light in a different angular distribution from the second light output from the fluorescent substance region, the reflection region being provided in the wavelength conversion section; and
a region-division wavelength selector including a first region and a second region, the first region transmitting the first light and the second light, the second region reflecting or absorbing the second light selectively.
